(19) United States
(12) Patent Application Publication
(10) Pub. No.: US 2024/0095852 A1
(43) Pub. Date: Mar. 21, 2024

(54) SYSTEM, METHOD AND COMPUTER READABLE MEDIUM FOR INTERACTIONS BETWEEN AN EMPATHETIC PROFILE OF A DECEASED INDIVIDUAL AND A USER

(71) Applicant: Arbor Memorial Inc., Toronto (CA)

(72) Inventors: Paul Scanlan, Mississauga (CA); Michael Scanlan, Toronto (CA); David Scanlan, Mississauga (CA); Bobbi-Lynn Morgan, Beamsville (CA); Robert Givens, Toronto (CA); Kirk Serjeantson, Markham (CA)

(73) Assignee: Arbor Memorial Inc., Toronto, ON (CA)

(21) Appl. No.: 18/455,760

(22) Filed: Aug. 25, 2023

Related U.S. Application Data
(63) Continuation of application No. 63/408,386, filed on Sep. 20, 2022.

(51) Int. Cl. G06Q 50/00

(52) U.S. Cl. CPC G06Q 50/01

(57) ABSTRACT

The present disclosure provides a system and method for generating an empathetic profile and sending messages to a living individual. The system and method includes a processor configured to create the empathetic profile using personal data of a deceased individual, to create a user profile using personal data of the living individual, and to create a relationship link in a database of relationships between the empathetic profile and the user profile based on association data and similarities in data between the empathetic profile and the user profile. The processor is further configured to generate a message to be sent by a communications interface when a trigger condition is met, wherein the content of the generated message is based on the empathetic profile, the user profile and the relationship link. The system and method further includes a memory to store the empathetic profile, the user profile and the database of relationships.

### FIELD OF INVENTION

This present disclosure relates to a system, method and computer readable medium for generating and sending messages emulating deceased individuals. More specifically, a system, method and computer readable medium for generating and sending messages emulating deceased individuals and dynamically adjusting based on a user's response.

### BACKGROUND OF THE INVENTION

There is a declining market for traditional memorialization, such as a traditional funeral, burial plot and burial monuments. Furthermore traditional memorializations are typically one time events, and do not provide additional interactions once the one time event is over. The engagement between loved ones and the deceased are limited to the one time events and do not span over time.

In addition, traditional memorialization is typically not as engaging. While the memory of a deceased loved one is certainly at the forefront of the mind during a funeral, after the passage of time, the memory may fade. Keeping the memory of a deceased loved one active is difficult.

In addition, memories of the deceased are typically generated by their loved ones after the death of the loved one, and is rarely shared amongst other family members or friends.

### SUMMARY OF THE INVENTION

According to various aspects to the present invention, there is provided a system for generating an empathetic profile and sending messages to a living individual. The system includes a processor configured to create the empathetic profile using personal data of a deceased individual. The processor is further configured to create a user profile using personal data of the living individual. The processor is also configured to create a relationship link in a database of relationships between the empathetic profile and the user profile based on association data and similarities in data between the empathetic profile and the user profile. Furthermore, the processor is configured to generate a message to be sent by a communications interface when a trigger condition is met. The content of the generated message is based on the empathetic profile, the use profile and the relationship link. The system also includes a memory to store the empathetic profile, the user profile and the database of relationships between the empathetic profile and the user profile.

The system may include the processor being further configured to determine if the empathetic profile includes a social media account. If the social media account is present, the processor is further configured to generate and send a request through the communication interface to a social media provider to change the status of the social media account of the deceased individual associated with the empathetic profile to a deceased status.

The system may include the memory further storing a pre-programmed empathetic profile and a templated pre-programmed user profile, and where the processor is further configured to match the empathetic profile to a templated pre-programmed empathetic profile and match the user profile to a templated pre-programmed user profile. The processor is further configured to verify the relationship link using the templated pre-programmed empathetic profile and the templated pre-programmed user profile and add details to the relationship link using the templated pre-programmed empathetic profile and the templated pre-programmed user profile.

The trigger condition may be a location of a known device associated with the user profile matching a location stored in the empathetic profile.

Alternatively, the trigger condition may be a date of significance to the deceased individual stored in the empathetic profile.

The generated message may be sent using the communication interface to the user interface to be displayed on the user interface.

Alternatively, the generated message may be sent using the communication interface to a social media account associated with the user profile.

Alternatively, the generated message may be sent using the communication interface via SMS to a phone number associated with the user profile.

The communication device may be further configured to receive a response to the generated message from the living individual associated with the user profile. The processor may be further configured to analyse the response to determine a degree of engagement of the living individual and update the trigger condition based on the degree of engagement of the living individual.

According to various aspects to the present invention, there is provide a method for generating an empathetic profile and sending messages to a living individual. The method includes creating an empathetic profile using personal data of a deceased individual, the empathetic profile stored in a memory. The method further includes creating a user profile using personal data of the living individual, the use profile stored in the memory. The method also includes creating a relationship link in a database of relationships between the empathetic profile and the user profile based on association data and similarities in data between the empathetic profile and the user profile, where the database of relationships is stored in the memory. The method also includes generating a message to be sent by a communications interface when a trigger condition is met, where the content of the generated message is based on the empathetic profile, the user profile and the relationship link. The method further includes sending the generated message.

The method may include determining if the empathetic profile includes a social media account, and if the social media account is present, the method may further include generating and sending a request through the communication interface to a social media provider to change the status of the social media account of the deceased individual associated with the empathetic profile to a deceased status.

The method may further include matching the empathetic profile to a templated pre-programmed empathetic profile, where the templated pre-programmed empathetic profile is stored in memory. The method may also include matching the user profile to a templated pre-programmed user profile, where the templated pre-programmed user profile is stored in memory. The method may also include verifying the relationship link using the templated pre-programmed empathetic profile and the templated pre-programmed user profile. The method may further include adding details to the relationship link using the templated pre-programmed empathetic profile and the templated pre-programmed user profile.

The trigger condition may be a location of a known device associated with the user profile matching a location stored in the empathetic profile.

Alternatively, the trigger condition may be a date of significance to the deceased individual stored in the empathetic profile.

The generated message may be sent using the communication interface to the user interface to be displayed on the user interface.

Alternatively, the generated message may be sent using the communication interface to a social media account associated with the user profile.

Alternatively, the generated message may be sent using the communication interface via SMS to a phone number associated with the user profile.

The method may further include receiving a response to the generated message from the living individual associated with the user profile, analysing the response to determine a degree of engagement of the living individual and updating the trigger condition based on the degree of engagement of the living individual.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 depicts a system for generating interactions between an empathetic profile of a deceased individual and a user;

FIG. 2 depicts a diagram of interactions between the system in FIG. 1 and other external systems;

FIG. 3 depicts a diagram of inputs that may be received by the system in FIG. 1;

FIG. 4 depicts a diagram of how inputs received by the system in FIG. 1 may be used to generate dynamic family trees;

FIG. 5 depicts a diagram of how inputs received by the system in FIG. 1 may be used to interact with user devices, including generating interactions between an empathetic profile of a deceased individual and a user;

FIG. 6 depicts a diagram of how inputs received by the system in FIG. 1 may be used in relation to other users of the system within the community;

FIG. 7 depicts a diagram of how FIGS. 2, 3, 4, 5, and 6 interact with each other;

FIG. 8 depicts a method for generating interactions between an empathetic profile of a deceased individual and a user using the system in FIG. 1;

FIG. 9 depicts a flowchart of user functions when interacting with the system in FIG. 1 through a user device with a graphical user interface;

FIG. 10 depicts a user profile for a user that may interact with an empathetic profile of a deceased individual using the system in FIG. 1;

FIG. 11 depicts a screenshot of the graphical user interface for a user to log in on a user device in the system in FIG. 1;

FIG. 12 depicts a screenshot of the graphical user interface for a user to create an account and provide information relating to the user's name, email, password and date of birth on a user device in the system in FIG. 1;

FIG. 13 depicts a screenshot of the graphical user interface of a user's feed showcasing recent or relevant events of other users on a user device in the system in FIG. 1;

FIG. 14 depicts a screenshot of the graphical user interface of memories or photos that a user published previously, and of memories or photos that were published by other users previously on a user device in the system in FIG. 1;

FIG. 15 depicts a screenshot of the graphical user interface of a user's family tree on a user device in the system in FIG. 1;

FIG. 16 depicts a screenshot of the graphical user interface of another user's photographs and memories, or of photographs and memories published on a deceased individual's user page on a user device in the system in FIG. 1;

FIG. 17 depicts a screenshot of the graphical user interface to leave a memory, message or photograph on another user's profile, or on a deceased individual's user page on a user device in the system in FIG. 1;

FIG. 18 depicts a screenshot of the graphical user interface to purchase items to be gifted towards a deceased individual on a user device in the system in FIG. 1;

FIG. 19 depicts a screenshot of the graphical user interface to track locations in which a user's family has been, and where memories or photographs were taken with a deceased individual on a user device in the system in FIG. 1.

### DESCRIPTION OF THE PREFERRED EMBODIMENTS OF THE INVENTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

By way of general overview, there is provided a system and method for generating and interacting between an empathetic profile of a deceased individual and a user. In addition, a user may share memories, photographs, notes or other digital media with other users related to the deceased individual. By interacting with the empathetic profile of a deceased individual and sharing digital media, the memories of a loved one that is deceased may be kept alive and remembered over a long period of time.

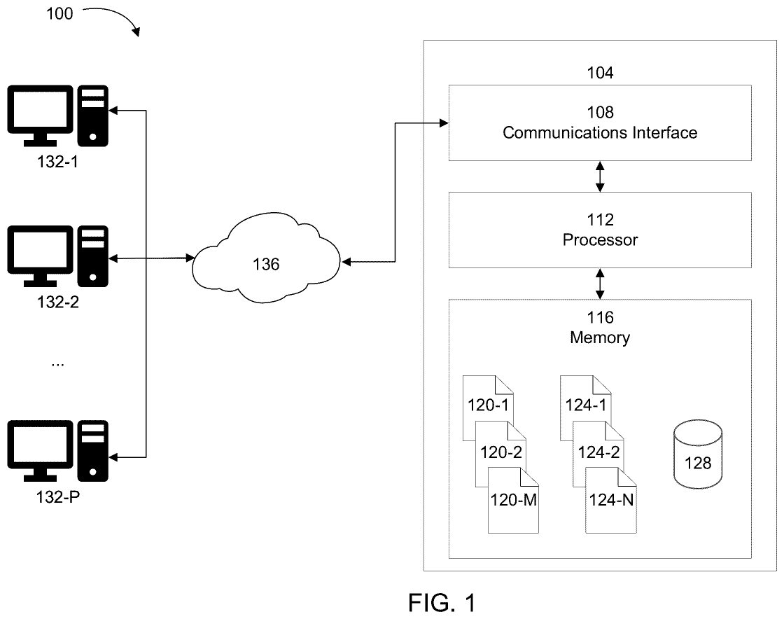

FIG. 1 depicts a system 100 for generating and interacting between an empathetic profile of a deceased individual and a user. System 100 includes processing server 104 and a client terminal 132-1 or a plurality of client terminals 132-1, 132-2 . . . 132-P. (Client terminals 132 are referred to here generically as client terminal 132 and collectively as client terminals 132. This nomenclature is used elsewhere herein.) Processing server 104 connects to client terminals 132 via a wide area network 136. Hereafter, wide area network 136 will be referred to as WAN 136.

Processing server 104 includes processor 112 interconnecting memory 116 and a communications interface 108. Processor 112 can include a central-processing unit (CPU), a microcontroller, a microprocessor, a processing core, a field-programmable gate array (FPGA), or similar. The processor 112 can include multiple cooperating processors. Processor 112 can cooperate with non-transitory computer readable medium such as memory 116 to execute instructions to realize the functionality discussed herein. Memory 116 can include a combination of volatile (e.g. Random Access Memory or RAM) and non-volatile memory (e.g. read only memory or ROM, Electrically Erasable Programmable Read Only memory or EEPROM, flash memory). All or some of the memory 116 can be integrated with processor 112. Memory 116 stores computer readable instructions for execution by processor 112.

In particular, memory 116 stores a plurality of computer-readable data and programming instructions, accessible by processor 112, in the form of software objects such as various applications, queries, or types of data for use during the execution of those applications. In particular, the execution of the instructions in memory 116 by processor 112 generates messages to be sent as part of an empathetic profile of a deceased individual to a user, and also determines when to send said messages. A person skilled in the art will now recognize that various forms of computer-readable programming instructions stored in memory 116 can be executed by processor 112 as applications or queries.

Memory 116 also stores a plurality of empathetic profiles of deceased individuals 120-1, 120-2 . . . 120-M (also referred to herein as empathetic profiles 120), a plurality of user profiles of living individuals 124-1, 124-2 . . . 124-N (also referred to herein as user profiles 124) and a database of relationships 128. Empathetic profiles 120, user profiles 124 and database 128 may be consolidated on a single server as depicted in FIG. 1, or may be on separate machines or servers in the same network.

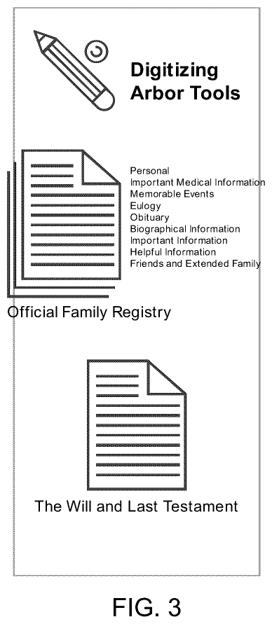

Empathetic profiles 120 are profiles that represent a deceased individual and store data about said deceased individual. Referring to FIG. 3, the data stored within empathetic profiles 120 may include but are not limited to biographical information (such as date of birth), personal information, important medical information, memorable events that said deceased individual experienced, the eulogy and the obituary of said deceased individual, the will and last testament of said deceased individual, likes, dislikes, career information, musical preferences, social media account information, geographical locations the individual frequented or lived in, most often used platform for communication and any other important or helpful information/traits that may describe the deceased individual. An accurate empathetic profile 120 allows processor 112 to utilize the data to mimic the deceased individual when generating messages to send to users. The more information provided in empathetic profile 120, the more accurate the empathetic profile 120 may be when representing the deceased individual. A person skilled in the art will recognize that an empathetic profile may contain any number of traits or data that is related to the deceased individual.

Empathetic profiles 120 may also include digital media including, but not limited to photographs, videos, audio files and personal notes relating to the deceased individual. The digital media may be saved as part of empathetic profile 120 in memory 116. Users may browse through the digital media associated with empathetic profiles 120 to remind themselves of fond memories of the deceased. Furthermore, the digital media may appear in the news feed on the graphical user interface on client terminal 132 of related users. How users are related will be discussed further below.

Data regarding the deceased individual may be obtained from a user through client terminal 132. Through the graphical user interface on client terminal 132, an account may be created for the deceased individual, where the aforementioned data may be provided, and the empathetic profile 120 created.

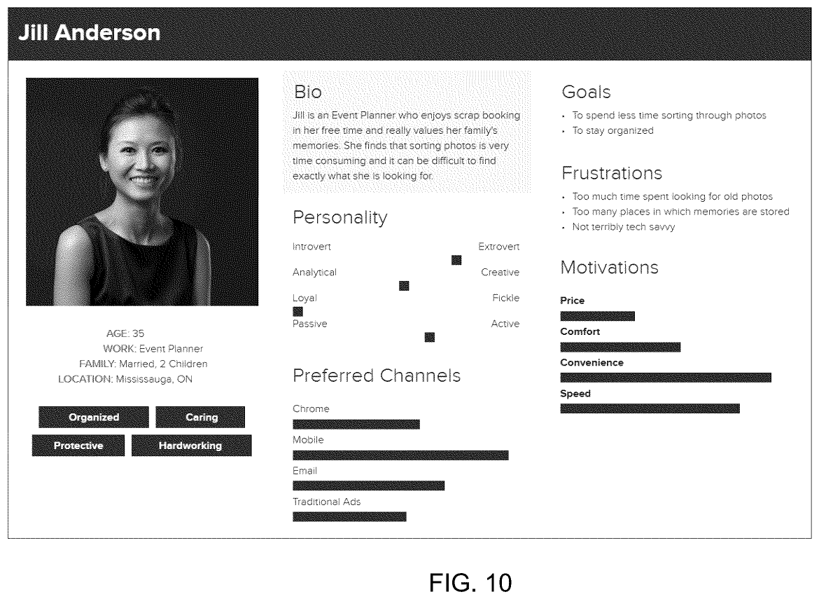

Returning to FIG. 1, memory 116 also includes user profiles 124. User profiles 124 are profiles that represent a user that has a connection/is related to the deceased individual. The user may be a family member to the deceased individual, or a friend to the deceased individual. Data stored within user profiles 124 may include but are not limited to biographical data, goals, personality info, career data, the user's resume and curriculum vitae, professional organizations and volunteer organizations that the user was a part of, associations that the user was a member of, education history, traits, geographical data, social media account information, most often used platform for communication and motivations. An example of a user profile can be seen in FIG. 10.

Returning to FIG. 1, similar to empathetic profiles 120, user profiles 124 may also include digital media. The digital media may appear on the news feeds on the graphical user interface on client terminal 132 of related users.

User profiles 124 may be created by providing data to processing server 104 through the graphical user interface on client terminal 132. An account may be created for the user, where data is entered and saved associated to the account and user profile 124.

User profiles 124 may also be converted into empathetic profiles 120. In the event that user or family member has an existing user profile 124, and that user or family member passes away, user profile 124 of that user or family member may be converted into empathetic profile 120. Conversion of an existing user profile 124 to empathetic profile 120 may be triggered either through input into the system, or alternatively may be triggered through external databases. For example, a funeral home may have a database containing the ownership of funeral plots. The funeral plots may be pre-purchased and reserved for a person who is still living. Upon said person passing away, the record of the funeral plot within the database may be updated. When updating the record, a request may also be sent to system 100 to convert user profile 124 into empathetic profile 120. A person skilled in the art will recognize that various triggers or information exchanges may allow for the conversion of user profile 124 into empathetic profile 120.

Memory 116 further includes database 128. Database 128 is configured to store the relationships between empathetic profiles 120 and user profiles 124, as well as any details regarding the relationship. Database 128 also allows processor 112 to determine which users are related to each other, and which users are related to a deceased individual. In the current embodiment, database 128 allows processor 112 to determine to which users messages should be sent to, the potential triggers for generating and sending messages to users, the frequency of sending messages to users, and a preferred method or platform for communication. In alternate embodiments, the potential triggers and the frequency of sending messages and other details may also reside in user profiles 124.

An example of a relationship provided in database 128 is where the deceased individual is a wife and a mother to one. In this example, an empathetic profile 120 is created to represent the deceased individual, the wife and mother of one, along with important dates, and important locations. The locations may be represented as GPS coordinates. Family members and close friends may then create user profiles 124. For the single child, a user profile 124 may be created, and related to the aforementioned empathetic profile 120 as a “child” relationship. For the husband, a user profile 124 may be created and related to the aforementioned empathetic profile 120 as a “spouse” relationship. The properties of both of these relationships may then be used by processor 112 to generate messages. For example, for the “spouse” relationship, there may be properties regarding the length of the marriage and the date of marriage, allowing processor 112 to generate and send a message on the anniversary from empathetic profile 120 representing a message from the deceased wife to the husband user wishing him a happy 30th anniversary. A person skilled in the art will recognize that different data, relationship types and relationship properties may be stored in database 128, and allow for processor 112 to generate different messages to send to related users.

Processing server 104 also includes communications interface 108 interconnected with processor 112. Communications interface 108 includes suitable hardware (e.g. transmitters, receivers, network interface controllers and the like) allowing processor 108 to communicate other computing devices, such as client terminal 132.

Furthermore in other embodiments, communications interface 108 may be connected to a network, the internet or other databases for information, allowing processor 112 to communicate with other computer devices, or other databases for information. This will be further discussed below. Specific components of communications interface 108 are selected based on the type of network or other links that processor 112 is required to communicate over.

Processing server 104 may also include input devices (not shown) that connect to processor 112, such as a keyboard or a mouse, as well as output devices, such as a display. Alternatively, or in addition, the input and output devices, can be connected to processor 112 via communications interface 108 via another computing device. In other words, input and output devices can be local to processing server 104, or remote. A person skilled in the art will now recognize the availability of different input and output devices and that there are a variety of methods of connecting to processor 112.

System 100 further includes client terminals 132. Client terminal 132 may act as a user input terminal to provide information to processing server 104. A user may, through a graphical user interface, provide inputs, receive outputs, and generally interact with processing server 104 using client terminal 132. Client terminal 132 can be a computer device such as, but not limited to, a desktop computer, a laptop computer, another server, a kiosk, a cell phone, a tablet, a mobile device, a monitor or other suitable device. The graphical user interface will be further described below.

Each client terminal 132 is connected to processing server 104 over WAN 136. A person skilled in the art will recognize that WAN 136 is not limited in its configuration. For example, WAN 136 may be implemented over the Internet, as is in the current embodiment. Any desired levels and types of security and encryption protocols are contemplated and can be implemented over WAN 136.

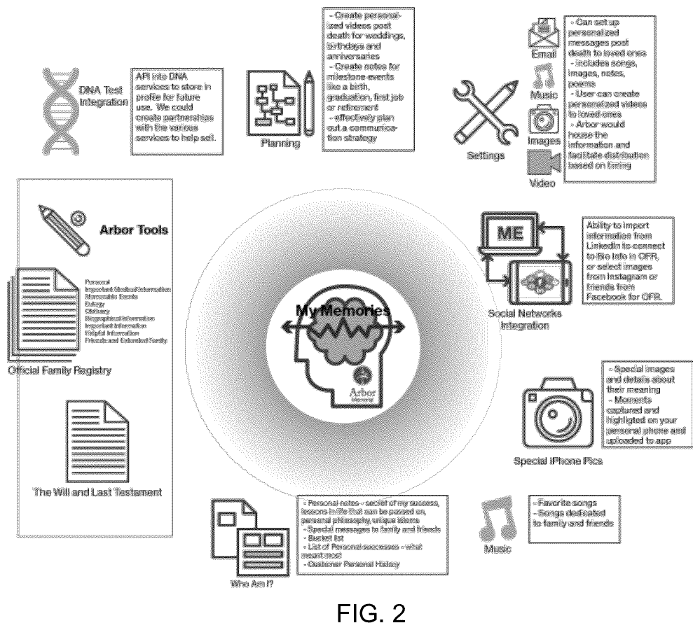

As previously mentioned, photographs and other forms of digital media may be stored in memory 116 in association with both empathetic profiles 120 and user profiles 124. These photographs and other forms of digital media may also be referred to as memories. FIG. 2 depicts the different uses and sources of memories. For example, memories may be used to create personalized videos for future weddings, birthdays and anniversaries, despite the passing away of the deceased individual. In addition, digital media may also be included in the messages that are sent to related users. Furthermore, memories may be imported from or exported to social media. For example, photographs from the deceased individual's social media page may be imported and saved into memory 116 to be used for generating messages. Alternatively, photographs may be exported to social media by users, who wish to share a photograph of someone who has been deceased.

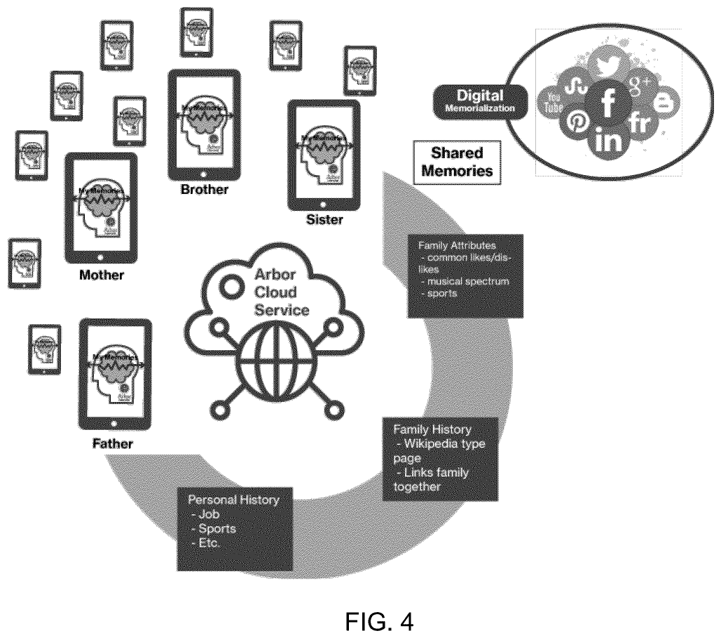

FIG. 4 depicts the sharing of memories and data between related users. The relationships from database 128 may also be used to create a family history or family tree to depict the relationships between related users. Data showcasing traits of users, such as likes, dislikes, musical preferences and favorite sports may also be shared between users, allowing processor 112 to find similarities between users. Similarities between users may be highlighted and depicted to related users on the graphical user interface on client terminal 132. For example, if two related users had a common like of travelling, this would be highlighted on each of the two users on the graphical user interface of their respective client terminals 132.

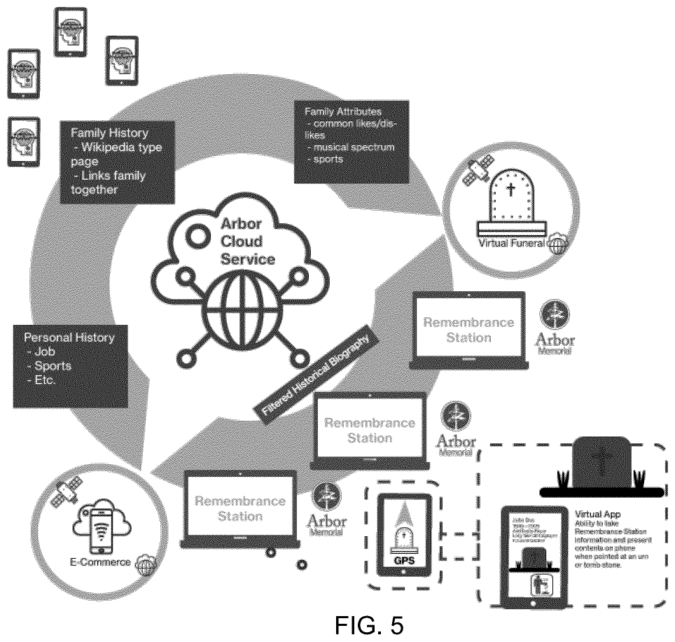

FIG. 5 depicts the use of data in empathetic profiles 120 and user profiles 124 in various services provided by system 100. These services include, but are not limited to, providing an e-commerce platform based on the traits and preferences of an empathetic profile 120 of a deceased individual or the traits and preferences of a user profile 124, providing a virtual funeral that may be enhanced based on the preferences of an empathetic profile 120 of a deceased individual, or providing information about a deceased individual when a mobile device acting as client terminal 132 is located at the GPS coordinates of the deceased individual's gravesite.

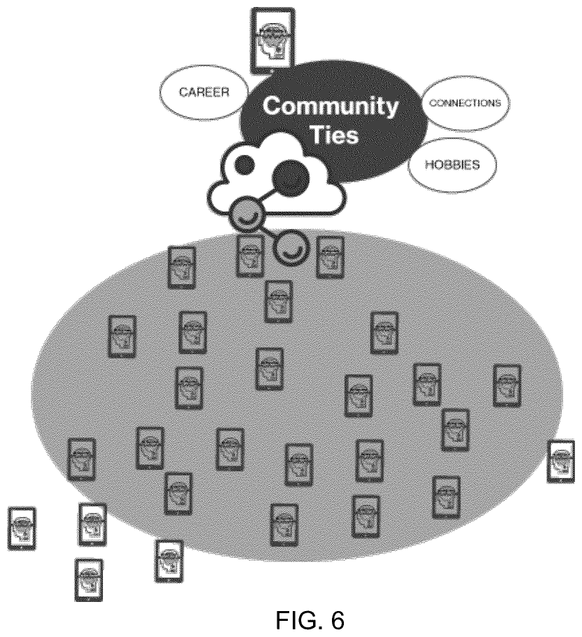

FIG. 6 depicts potential connections between related users linked to a single family, or related to a deceased individual, and other groups of related users linked to another family, or related to other deceased individuals.

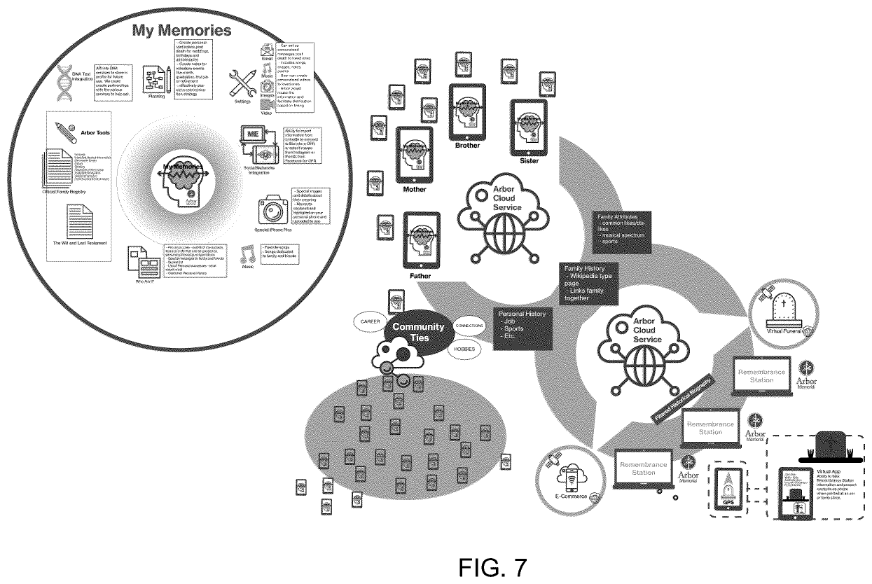

FIG. 7 depicts system 100 when the services and features provided in FIGS. 2, 4, 5, and 6 are put together.

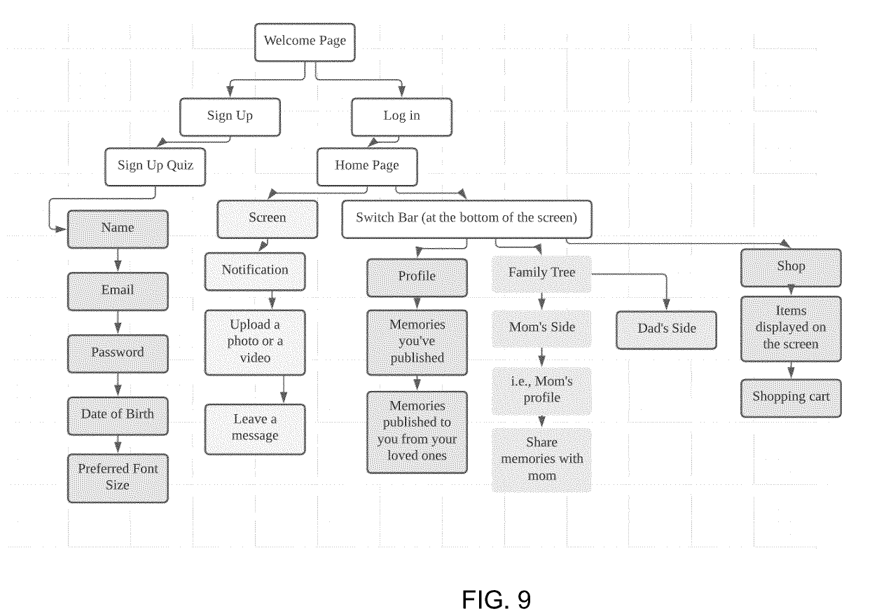

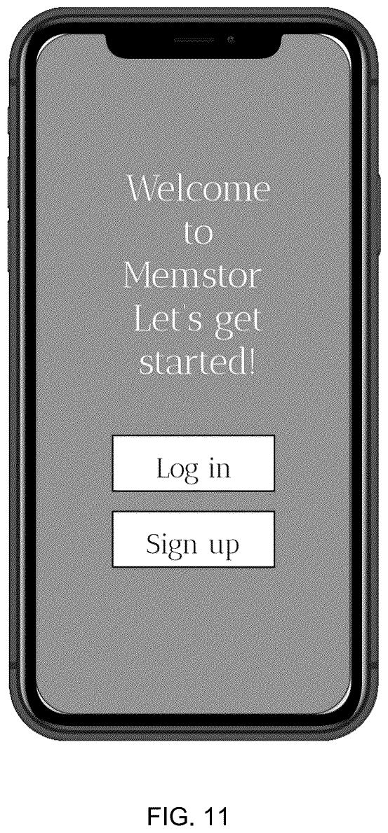

The graphical user interface on client terminal 132 allows a user to interact with processing server 104 to access the aforementioned services and features. FIG. 9 provides a flowchart of the various screens that may be displayed on the graphical user interface. FIGS. 11 to 19 provide example screenshots of said various screens that may be displayed on the graphical user interface.

FIG. 11 depicts the main entry screen, where users may log in to their account, or where new users may sign up for their accounts.

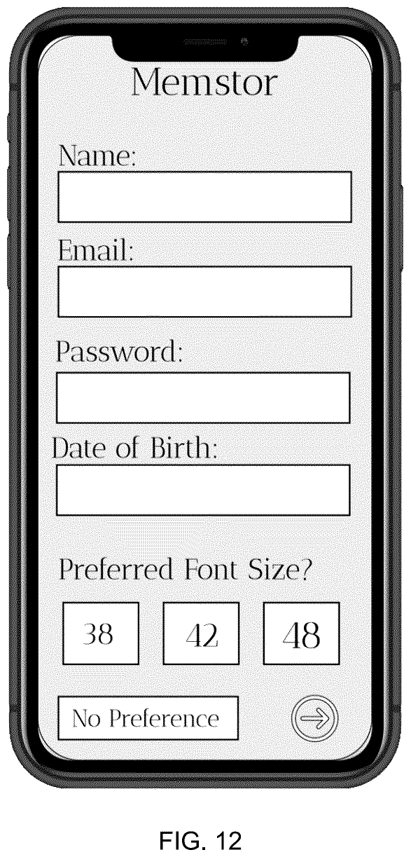

FIG. 12 depicts the input form where new users may sign up for their accounts.

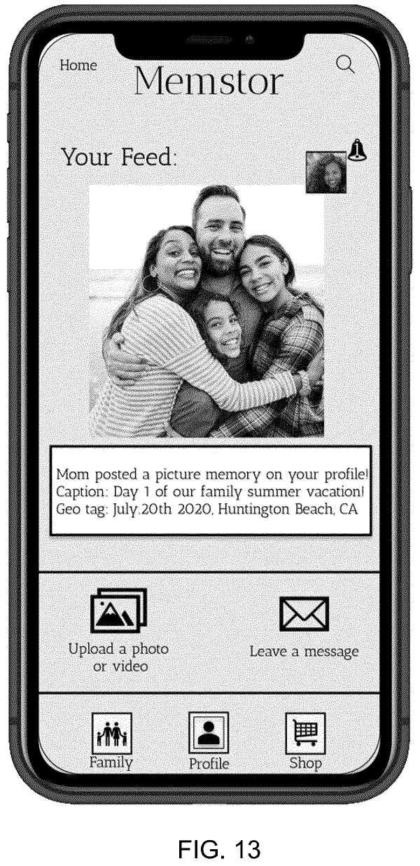

FIG. 13 depicts a user's feed, where new alerts are posted, and where new or relevant digital media is shared with related users. A user may also upload additional digital media on this screen.

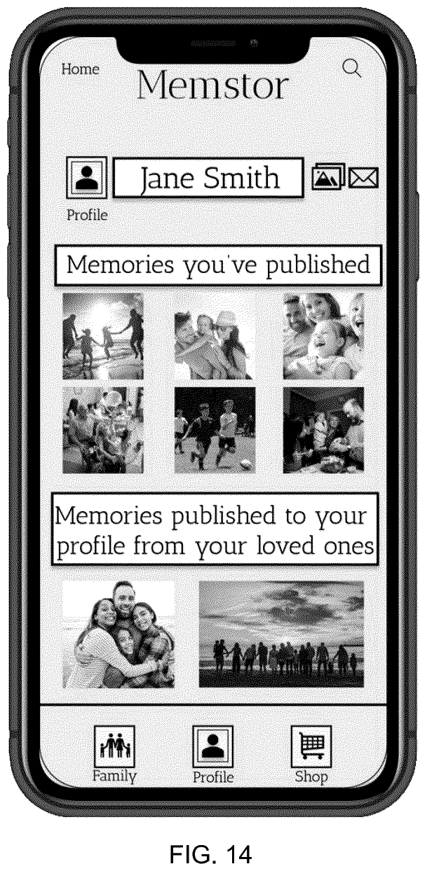

FIG. 14 depicts the digital media that has been uploaded previously by the user, and other digital media that was previously uploaded by other related users.

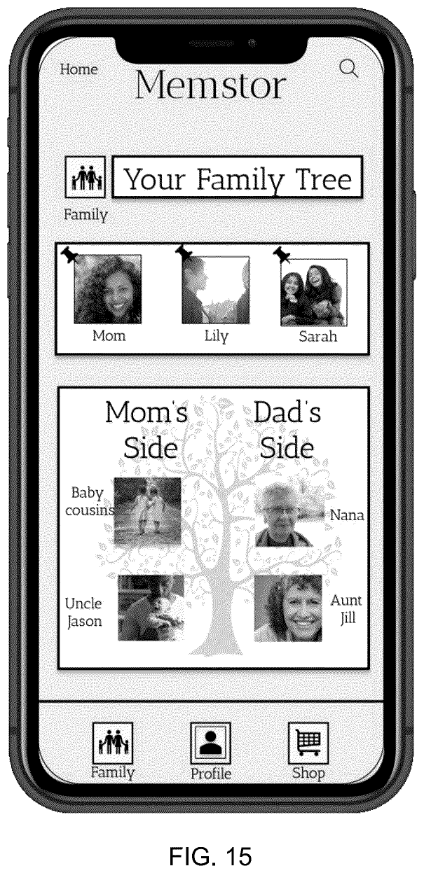

FIG. 15 depicts a family tree of related users.

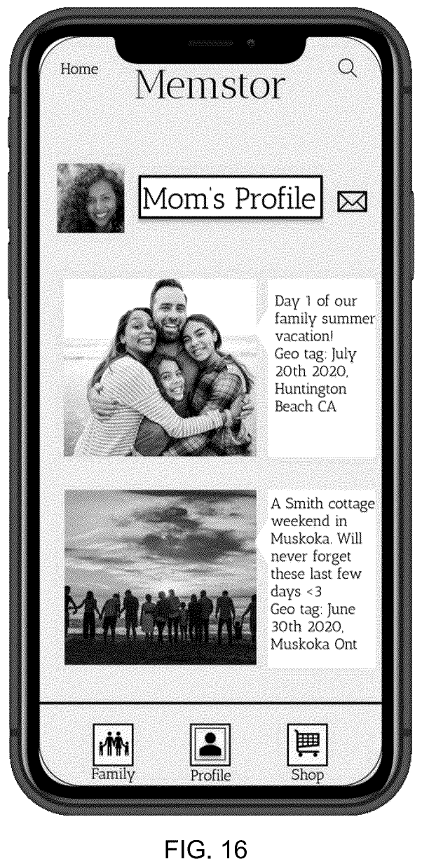

FIG. 16 depicts an empathetic profile 120 page, along with digital media associated with the deceased individual. User profile 124 pages may be similar.

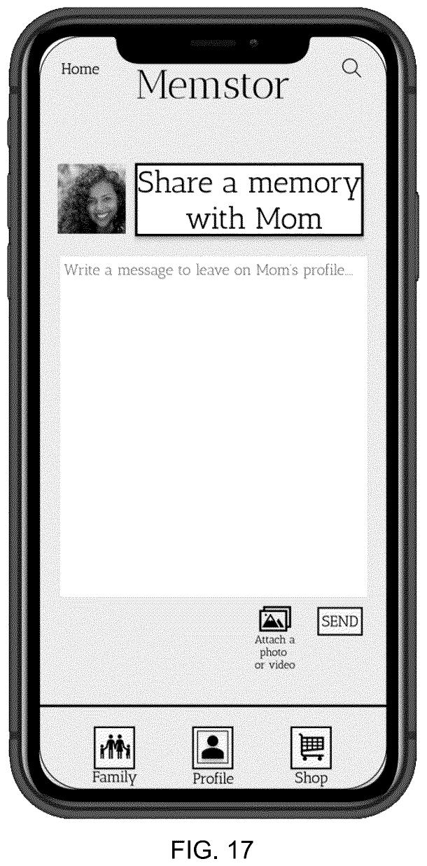

FIG. 17 depicts the ability to share text and digital media with other users by associating the text and digital media to a deceased individual and hence an empathetic profile 120, and uploading the text and digital media to memory 116.

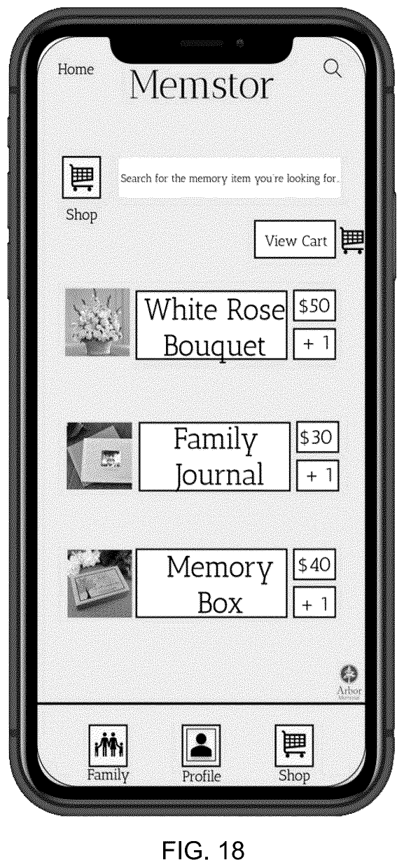

FIG. 18 depicts a screen for users to purchase goods for either themselves, or to be gifted to deceased individuals or other users.

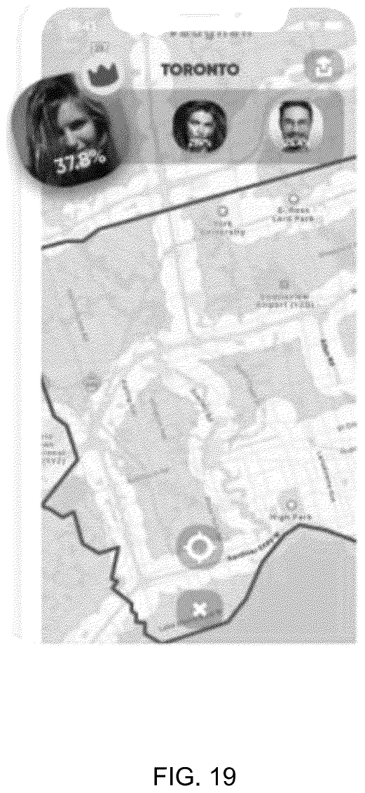

FIG. 19 depicts a screen showcasing locations frequented by the deceased individual. As will be discussed below, visiting these locations may meet a trigger condition for receiving messages from empathetic profile 120.

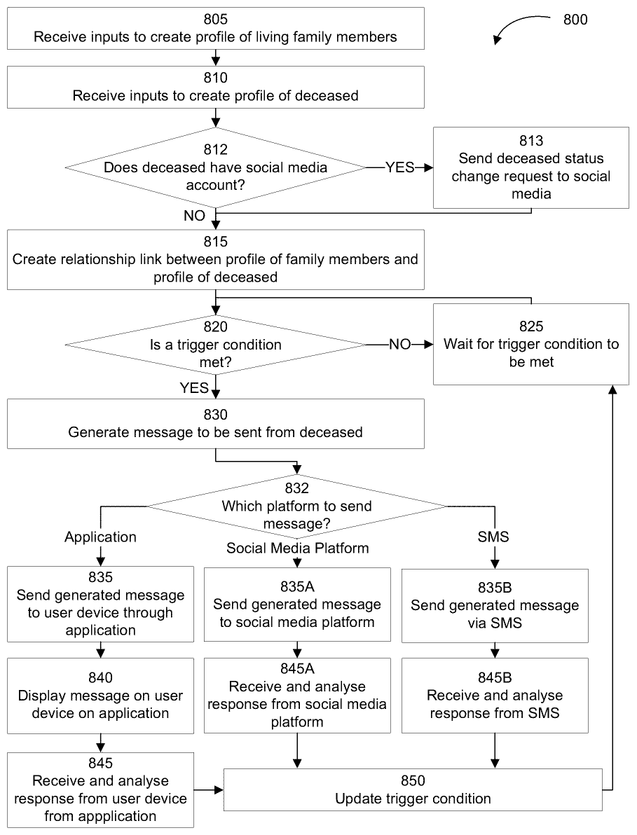

Referring to FIG. 8, a method 800 of generating and sending messages between an empathetic profile 120 of a deceased individual and a user using system 100. Messages are generated based on the data from empathetic profile 120, user profiles 124 and database 128, and are tailored to the user receiving the messages.

At block 805, inputs are received to create user profile 124. Inputs, such as the personal data of the deceased individual, the personal data of the living individual or user, and association data about the relationship between the deceased individual and the living individual, are requested from the user through the graphical user interface. Inputs are then received at client terminal 132, and sent to processor 112 via WAN 136 and communications interface 108. Processor 112 can then generate user profile 124. User profile 124 may then be saved in memory 116. A person skilled in the art will recognize that the more data received, the more accurate a user profile 124, and the more relationships may be formed between user profiles 124 of the same family based on traits or variables of the user profiles 124, and/or data of the empathetic profile 120 of the deceased family member.

At block 810, inputs are received to create empathetic profile 120. Similar to the aforementioned generation of user profile 124 in block 805, inputs are requested from the user through the graphical user interface. Inputs are then received at client terminal 132, and sent to processor 112 via WAN 136 and communications interface 108. Processor 112 can then generate empathetic profile 120 based off the received inputs. Empathetic profile 120 may then be saved in memory 116. A person skilled in the art will recognize that the more data received, the more accurate an empathetic profile 120 may reflect a deceased individual.

A person skilled in the art will recognize that blocks 805 and 810 are not limited to a specific order of operations. While depicted as block 805 occurring prior to block 810, in other embodiments, block 805 may occur after block 810, or block 805 may occur concurrently with block 810. An example of block 805 occurring prior to block 810, may include if a family creates user profiles 124 at block 805 in anticipation of a family member passing away in the future, similar to family members purchasing funeral plots prior to any family member passing away. After a family member passes away, at block 810, empathetic profile 120 may be created either from new inputs, or an existing user profile 124 may be converted into empathetic profile 120. Alternatively, an example of block 805 occurring after block 810 may include if the family of the deceased does not have user profiles 124 and the deceased does not have an empathetic profile 120. In this example, empathetic profile 120 may be created first at block 810, after which, the family may create user profiles 124 at their discretion. In another example, block 805 and block 810 may be created concurrently, where the family of the deceased may create user profiles 124 and the empathetic profile 120 of the deceased at the same time. A person skilled in the art will recognize the different scenarios that may lead to the creation of user profiles 124 and empathetic profiles 120 and hence the order of blocks 805 and 810.

In alternative embodiments, empathetic profile 120 and user profile 124 may be matched to pre-programmed profile templates stored in memory 116. More specifically, empathetic profile 120 may be matched to a templated pre-programed empathetic profile, and user profile 124 may be matched to a templated pre-programed user profile. While pre-programmed profile templates may aid in providing a finite number of relationships and hence provide ease in programming, it may not be as accurate as there is an estimation in a profile, rather than a representation of direct inputs.

In alternative embodiments, pre-programmed profile templates may also be used to provide guidance towards users and family members when generating empathetic profile 120 and user profile 124. By providing examples of pre-programmed templates to users as they generate empathetic profile 120 or user profile 124, users may have a guide as to how to complete the information required for empathetic profile 120 or user profile 124, and the information that may provide optimal empathetic profile 120 and user profile 124 to generate the best interaction possible, such as meaningful messages.

At block 812, processor 112 may determine whether the deceased individual has a social media account by reviewing the information of empathetic profile 120. If the deceased individual has a social media account, a request may be sent out via the communications interface 108 to the social media account provider to change the status of the individual to be deceased or to a deceased status. This is depicted at block 813.

At block 815, a relationship link is created based on the inputs received from client terminal 132. More specifically, a relationship link may be created based on the association data received from the inputs, and any similarities in data between the empathetic profile 120 and the user profile 124. For example, if the empathetic profile 120 representing the deceased individual is the mother of a family member with user profile 124, this may be entered as a record in database 128, creating the relationship link. Data associated with the relationship, or relationship properties may also be entered into database 128.

In an alternate embodiment, templated pre-programmed empathetic profiles and templated pre-programmed user profiles may be matched to empathetic profile 120 and user profile 124 respectively, and the relationship link may be verified using the templated pre-programmed empathetic profiles and templated pre-programed user profiles. For example, if there is a relationship link where both the templated pre-programmed empathetic profile and the templated pre-programmed user profile both have a similar love of sports, then it is likely empathetic profile 120 and user profile 124 may have a similar relationship link of loving sports. As such, the relationship link of loving sports can be verified, and if the relationship link of loving sports is not present between empathetic profile 120 and user profile 124, it may be added.

At block 820, processor 112 determines whether a trigger condition is met. If trigger conditions are not met, processor 112 continues to wait for trigger conditions to be met before proceeding, as depicted at block 825. If trigger conditions are met, processor 112 generates a message to be sent to the user, as depicted at block 830, where the content of the generated message may be based on empathetic profile 120, user profile 124 and the relationship link. Trigger conditions may include, but are not limited to, client terminal 132 being located at a specific set of GPS coordinates, or a specific date, such as a date of significance, that is provided either from empathetic profile 120, user profile 124 or database 128.

In an embodiment where client terminal 132 is located at a specific set of GPS coordinates, this may be a mobile device located at the gravesite of a deceased individual, or at the location previously frequented by the deceased individual. An example message that may be generated in this embodiment may be “Thank you for visiting me at my gravesite”.

In an alternate embodiment where a specific date has been provided, this may be the birthday of a related user or the anniversary between the deceased individual and a related user. An example message that may be generated in this embodiment may be “Happy Birthday” or “Happy Anniversary”. The message that is generated may even be more specific. For example, if the deceased individual is a spouse of a related user receiving the message, then the message generated may be more specific, such as “Happy Anniversary, my love” or “Happy Anniversary, from your loving wife”. In another example, the date the deceased individual met their partner or spouse may be provided, in which case a message such as “Happy Anniversary of the date we first met” may be generated. In an alternate example, the date that the deceased individual passed away may be provided, in which case an example message that may be generated to be sent on the anniversary of said date may be “I am thinking of you today on the anniversary of the date that I left you”. A person skilled in the art will recognize the different messages that can be generated based on data from empathetic profiles 120, user profiles 124 and database 128. Furthermore, a person skilled in the art will recognize the variations in trigger points that may affect the message being generated.

As previously stated, messages may also include digital media. The digital media may be photographs or videos retrieved from memory 116 as part of empathetic profile 120 or user profile 124. An example of a message with a digital media may be a message with a photograph of the deceased individual with the related user at a specific location. Said message with the photograph may be generated when the trigger condition of the client terminal 132 being at the GPS coordinates of the same location are met. A person skilled in the art will recognize the different messages that may be generated by retrieving relevant digital media from empathetic profiles 120 and user profiles 124 from memory 116.

The frequency of trigger conditions being met may be determined based on data from empathetic profile 120 and user profiles 124. This data may include the type of relationship between the deceased individual and the related user, and a level of closeness between the deceased individual and the related user. If there is a high level of closeness, then more trigger conditions may be added. If there is a low level of closeness, then trigger conditions may be removed, or in certain embodiments, the trigger conditions may be ignored despite being met. A person skilled in the art will recognize the different combinations of trigger conditions and its relation to the frequency of messages being generated and sent to users.

At block 832, processor 112 may determine the platform upon which to send the generated message. This may be done by reviewing empathetic profile 120 to determine if there are indications as to the platform that the deceased individual may have previously frequented. Alternatively, this may be done by reviewing user profile 124, to determine the platform that the family member or user frequents to ensure that the user receives messages from the deceased. In other embodiments, database 128 may have a preferred method or platform for communication, upon which processor 112 can determine the platform upon which to send the generated message.

In one embodiment, at block 835, the generated message is sent to client terminal 132 through a dedicated messaging application. The generated message may be sent by processor 112 via communications interface 108 and WAN 136 to client terminal 132. In an embodiment, where client terminal 132 is a mobile device, the message may be sent to the graphical user interface on client terminal 132.

At block 840, the message is displayed on client terminal 132 on the graphical user interface. In certain embodiments, the duration of time that the message is displayed may be measured and sent back to processor 112. Alternatively, the duration of time that a window is active with the message present may be measured and sent back to processor 112. Measurement of the duration of time that a message is displayed to a user on client terminal 132 measures the responsiveness and receptiveness of a user to the message.

A user may also respond to the message. The reply to the message and the aforementioned duration of time that the message is displayed on client terminal 132 may be analyzed by processor 112 at block 845. The response to the message may be analyzed based on length of the message. If the response is short in length, that may indicate that the user is not receptive to the message that was sent. If the response contains a larger amount of words or characters, that may indicate that the user is receptive to the message. By analyzing the length of the response and the duration of time that a message is displayed on client terminal 132, the receptiveness of the user to messages may be ascertained.

Once the degree of engagement or receptiveness of the user to messages is ascertained, the trigger conditions for future messages may be updated based on the degree of engagement, as depicted at block 850.

In alternate embodiments, the message generated at block 830 may be sent via social medial platform to a social media account associated with user profile 124, or posted on the social media account associated with user profile 124 as depicted at block 835A. Responses to the message, or replies to the post on social media may be received by processor 112 and analyzed based on length of the message at block 845A. Similar to block 845, if the response contains a larger amount of words or characters, that may indicate that the user that sent the reply is receptive to the message. This may impact the trigger conditions for future messages to be updated, as depicted at block 850.

In another embodiment, the message may be sent via SMS text message to client terminal 132, or to a phone number associated with user profile 124, as is depicted in block 835B. Similar to the above mentioned embodiments, the length of the message may be analyzed for receptiveness as is depicted in block 845B, after which, the trigger condition may be updated as is depicted at block 850. A person skilled in the art will recognize that messages being sent are not limited to a single mode of transmission, and may be sent from processing server 104 to client terminal 132 through a variety of methods.

While not depicted in FIG. 8, in other embodiments, the generation of messages, sending of messages, receiving of responses, analysis of responses, and the update of trigger conditions may all be logged into memory 116.

Processor 112 may then return to waiting for the new set of trigger conditions to be met, as depicted by the loop in method 800 back to block 825.

A person skilled in the art will recognize that there are different attributes relating to the messages and different attributes relating to responses to the messages that may be used to analyze a user's receptiveness.

Although the foregoing description and accompanying drawings relate to specific preferred embodiments of the present invention as presently contemplated by the inventor, it will be understood that various changes, modifications and adaptations, may be made without departing from the spirit of the invention.

1. A system for generating an empathetic profile and sending messages to a living individual, the system comprising:
a processor configured to:
create the empathetic profile using personal data of a deceased individual;
create a user profile using personal data of the living individual;
create a relationship link in a database of relationships between the empathetic profile and the user profile based on association data and similarities in data between the empathetic profile and the user profile; and
generate a message to be sent by a communications interface when a trigger condition is met, wherein content of the generated message is based on the empathetic profile, the user profile and the relationship link; and
a memory to store the empathetic profile, the user profile, and the database of relationships between the empathetic profile and the user profile.

2. The system of claim 1, the processor further configured to determine if the empathetic profile includes a social media account, and if the social media account is present, the processor further configured to generate and send a request through the communication interface to a social media provider to change the status of the social media account of the deceased individual associated with the empathetic profile to a deceased status.

3. The system of claim 1, the memory further storing a templated pre-programmed empathetic profile and a templated pre-programmed user profile; and the processor further configured to:
match the empathetic profile to a templated pre-programmed empathetic profile;
match the user profile to a templated pre-programmed user profile;
verify the relationship link using the templated pre-programmed empathetic profile and the templated pre-programmed user profile; and
add details to the relationship link using the templated pre-programmed empathetic profile and the templated pre-programmed user profile.

4. The system of claim 1, wherein the trigger condition is a location of a known device associated with the user profile matching a location stored in the empathetic profile.

5. The system of claim 1, wherein the trigger condition is a date of significance to the deceased individual stored in the empathetic profile.

6. The system of claim 1, wherein the generated message is sent using the communication interface to the user interface to be displayed on the user interface.

7. The system of claim 1, wherein the generated message is sent using the communication interface to a social media account associated with the user profile.

8. The system of claim 1, wherein the generated message is sent using the communication interface via SMS to a phone number associated with the user profile.

9. The system of claim 1, the communication interface further configured to receive a response to the generated message from the living individual associated with the user profile; and the processor further configured to:
analyse the response to determine a degree of engagement of the living individual; and
update the trigger condition based on the degree of engagement of the living individual.

10. A method for generating an empathetic profile and sending messages to a living individual, the method comprising:
creating an empathetic profile using personal data of a deceased individual, the empathetic profile stored in a memory;
creating a user profile using personal data of the living individual, the user profile stored in the memory;
creating a relationship link in a database of relationships between the empathetic profile and the user profile based on association data and similarities in data between the empathetic profile and the user profile, the database of relationships stored in the memory;
generating a message to be sent by a communications interface when a trigger condition is met, wherein content of the generated message is based on the empathetic profile, the user profile and the relationship link; and
sending the generated message.

11. The method of claim 10, the method further comprising determining if the empathetic profile includes a social media account, and if the social media account is present, the method further comprising generating and sending a request through the communication interface to a social media provider to change the status of the social media account of the deceased individual associated with the empathetic profile to a deceased status.

12. The method of claim 10, the method further comprising:
matching the empathetic profile to a templated pre-programmed empathetic profile, the templated pre-programmed empathetic profile stored in memory;
matching the user profile to a templated pre-programmed user profile, the templated pre-programmed user profile stored in memory;
verifying the relationship link using the templated pre-programmed empathetic profile and the templated pre-programmed user profile; and
adding details to the relationship link using the templated pre-programmed empathetic profile and the templated pre-programmed user profile.

13. The method of claim 10, wherein the trigger condition is a location of a known device associated with the user profile matching a location stored in the empathetic profile.

14. The method of claim 10, wherein the trigger condition is a date of significance to the deceased individual stored in the empathetic profile.

15. The method of claim 10, wherein the generated message is sent using the communication interface to the user interface to be displayed on the user interface.

16. The method of claim 10, wherein the generated message is sent using the communication interface to a social media account associated with the user profile.

17. The method of claim 10, wherein the generated message is sent using the communication interface via SMS to a phone number associated with the user profile.

18. The method of claim 10, further comprising:
receiving a response to the generated message from the living individual associated with the user profile;
analysing the response to determine a degree of engagement of the living individual; and
updating the trigger condition based on the degree of engagement of the living individual.
